(19) United States
(12) Patent Application Publication
(10) Pub. No.: US 2007/0095337 A1
(43) Pub. Date: May 3, 2007

(54) FOLDING CAMPING STOVE

(75) Inventor: Robert F. Mosher II, Wichita, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: THE COLEMAN COMPANY, INC., Wichita, KS (US)

(21) Appl. No.: 11/563,527

(22) Filed: Nov. 27, 2006

Related U.S. Application Data
(63) Continuation-in-part of application No. 11/122,843, filed on May 5, 2005.
(60) Provisional application No. 60/577,418, filed on Jun. 4, 2004.

(51) Int. Cl. A47J 37/00

(52) U.S. Cl. 126/25 R

(57) ABSTRACT

A folding camping stove. The folding camping stove may be formed in a clamshell configuration, having two clamshells that fold outward to expose at least two cooking surfaces. A pivot point is provided on the folding camping stove. Each of the clamshells folds about the same pivot point. A fuel train for the clamshells is positioned at the pivot point. A regulator and adaptor assembly is provided for providing gas from a canister to the folding stove. The adaptor guides the gas coming from the regulator and directs it to a fuel train that directs the gas to opposite sides of the folding stove. Each of the clamshells includes a cooking grate. The cooking grates appear symmetrical from a top view, but are slightly offset relative to one another so that the clamshells may be folded inward relative to each other and the grates may nest together.

### REFERENCE TO RELATED APPLICATION

This application is a continuation in part of U.S. application Ser. No. 11/122,843, filed May 5, 2005, which claims the benefit of U.S. Provisional Application No. 60/577,418, filed Jun. 4, 2004, both of which are incorporated herein by reference.

### TECHNICAL FIELD OF THE INVENTION

The present invention relates to stoves, and more specifically to portable stoves.

### BACKGROUND OF THE INVENTION

Portable stoves are popular cooking appliances, especially for use while camping or picnicking. Portable stoves commonly are powered by combustible gasses, such as propane gas. A typical portable stove includes a stove frame, one or more burner assemblies arranged in the frame, and a gas supply, such as a gas canister, coupled to the burner assembly via a control valve. Smaller versions convenient for backpacking may be not much larger than the gas canister itself, while larger versions designed for group camping may be the size of a large briefcase.

Larger portable stoves typically are designed to rest on a picnic table and open and close in a manner similar to that of a hard-sided suitcase. As with a suitcase, there may be a handle in the middle of the long, narrow front panel for carrying the portable stove in the closed position.

While these larger, suitcase-style portable stoves work well for their intended purpose, there are some limitations to their use. Generally, the suitcase-style portable stoves require a separate table on which to rest, and must be level or near level on that table. In addition, although the suitcase-style portable stoves fold into a box configuration, they are still somewhat bulky for travel and storage. Care must be taken with the devices because there are often objects that extend outside the box configuration, such as gas line attachments or control knobs, which may need protection during storage and/or transport.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A folding camping stove is provided. In an embodiment, the folding camping stove is formed in a clamshell configuration, having two clamshells that fold outward to expose at least two cooking surfaces.

In accordance with an embodiment, two pivot points are provided on the folding camping stove. Each of the clamshells folds about a separate pivot point. In an embodiment, fuel trains for the two clamshells are positioned at the pivot points.

A regulator and manifold assembly is provided for providing gas from a canister to the folding stove. The manifold splits the gas coming from the regulator and directs it to opposite sides of the folding stove. In an embodiment, the manifold directs fuel to two fuel trains, one each positioned at the two pivot points. Each fuel train may include a fuel conduit that extends the width of the stove and about which the respective clamshell rotates.

The separate fuel trains and the manifold and regulator assembly provide a single regulator system that is capable of providing fuel to two opposite sides of the folding stove. In addition, the separate fuel trains permit the folding stove to be configured without having a fuel line crossing either pivot location, which permits the folding stove to be manufactured without the need for a flexible fuel line extending through the two pivot points. Moreover, in accordance with an embodiment, the clamshells pivot along their fuel trains, and the couplings attach at the pivot points.

In an alternate embodiment, a single fuel line connects to a linkage between the two clamshells, and fuel systems for the separate clamshells are connected to the linkage. At least one of the fuel systems is capable of rotation relative to the linkage without fuel loss, and may utilize, for example, o-ring connections to allow leak-proof rotation.

In accordance with an embodiment, each of the clamshells includes a cooking grate. The cooking grates appear symmetrical from a top view, but are slightly offset relative to one another so that the clamshells may be folded inward relative to each other and the grates may nest together. In this manner, more compact folding of the folding stove is provided.

In accordance with an embodiment, the folding stove is narrower at a central portion of the stove at which the fuel trains are located. The body of the clamshells extends outward beyond the central portion, and control knobs or any other features extending from this central section are protected by the remainder of the clamshells extending beyond these features.

In an alternate embodiment, a single fuel line connects to a hinge between the two clamshells, and fuel systems for the separate clamshells are connected to the linkage. At least one of the fuel systems is capable of rotation relative to the hinge without fuel loss, and may utilize, for example, o-ring connections to allow leak-proof rotation.

Other features of the invention will become apparent from the following detailed description when taken in conjunction with the drawings, in which:

### BRIEF DESCRIPTION OF THE DRAWINGS

FIG. 1 is a side perspective view of a folding stove in accordance with an embodiment of the invention;

FIG. 2 is a side perspective view of the folding stove of FIG. 1, folded outward into an open configuration;

FIG. 3 is a top view of the folding stove of FIG. 2;

FIG. 4 is a side perspective view of the folding stove of FIG. 1, with the stove opened more than 180 degrees;

FIG. 5 is a side view of the folding stove of FIG. 1;

FIG. 6 is a cross-sectional view taken along the section lines 6-6 of FIG. 3;

FIG. 7 is a cross-sectional view taken along the section lines 7-7 of FIG. 3;

FIG. 8 is a side perspective view of an alternate embodiment of a folding stove in accordance with the present invention;

FIG. 9 is an alternate embodiment of a fuel train system for the folding stove of FIG. 1.

FIG. 10 is a side perspective view of an alternate embodiment of a folding stove, folded outward into an open configuration;

FIG. 11 is a top view of the of the folding stove of FIG. 12; and

FIG. 12 is a partial cross-sectional view taken along the section lines 12-12 of FIG. 11.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

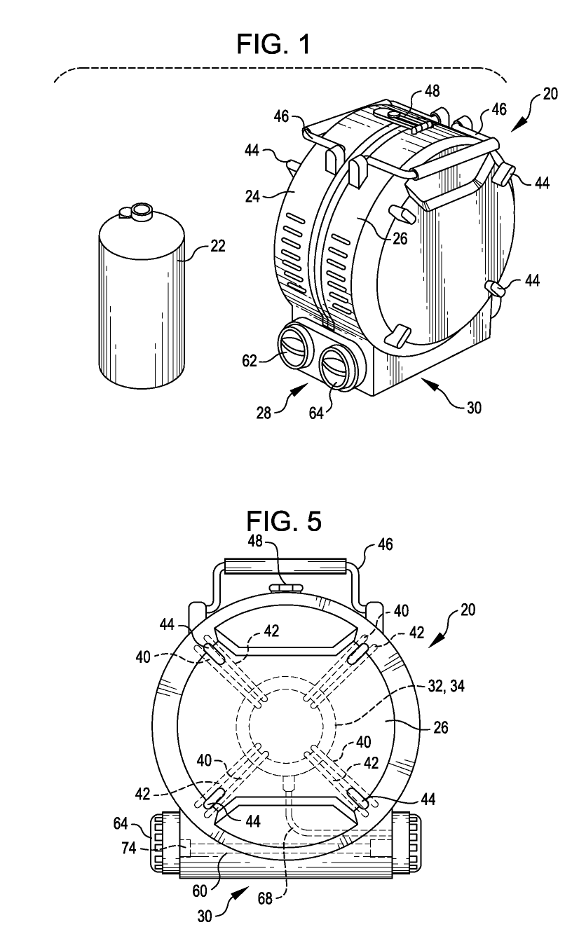

Referring now to the drawings, in which like reference numerals represent like parts throughout the several views, FIG. 1 shows a folding stove 20 in accordance with an embodiment of the invention. The folding stove 20 is designed for use with combustible gasses, such as propane gas, and may be provided fuel by, for example, a gas canister 22.

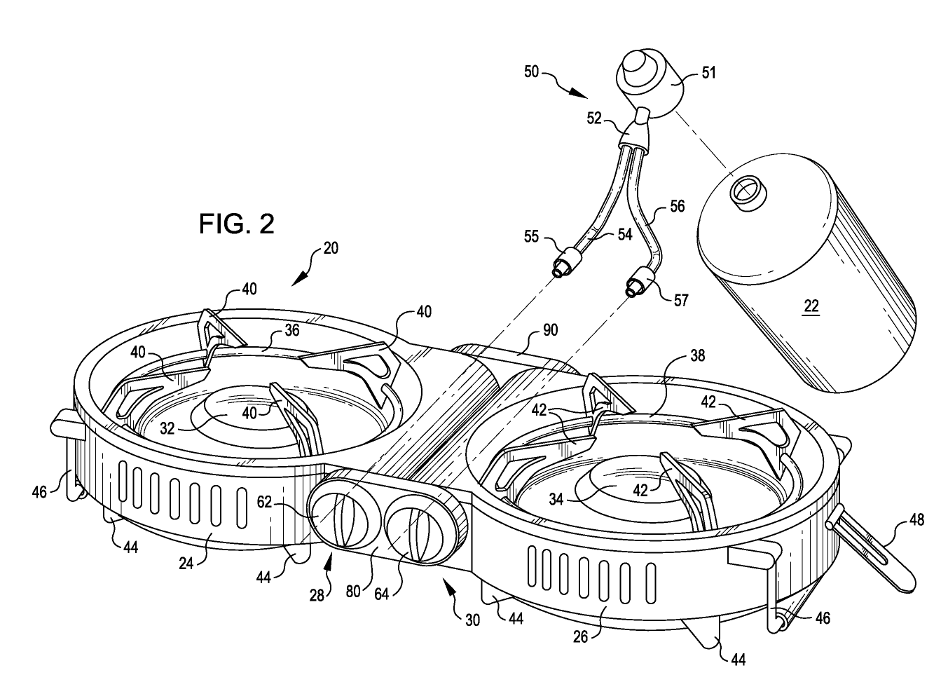

In accordance with an embodiment, the folding stove 20 includes two clamshells 24, 26. In a first configuration shown in FIG. 1, the two clamshells 24, 26 are folded together in a storage configuration. As can be seen in FIG. 2, the two clamshells 24, 26 may be rotated outward about two pivot points, in the embodiment shown, two fuel trains 28, 30, so that the folding stove 20 is in an opened configuration. In the opened configuration, burner eyes 32, 34, one each in the two clamshells 24, 26, are exposed as cooking surfaces.

By “fuel trains,” we mean the conduit system through which fuel flows to the burner eyes 32, 34. The numbers 28 and 30 (e.g., FIG. 2) in the drawings point generally to the area where these are located in the shown embodiment.

Although a single burner eye 32, 34 is shown on each clamshell 24, 26, more than one burner eye may be provided on one or both of the clamshells 24, 26. In the embodiment shown in the drawing, each of the burner eyes 32, 34 includes a cooking grate 36, 38 mounted around and partly over the respective burner eye 32, 34. As is known in the art, cooking grates, such as the cooking grates 36, 38, provide a platform on which a pot or other cooking vessel may be placed when heated by the respective burner eye 32, 34. In accordance with an embodiment, the platform is provided by a series of prongs 40, 42.

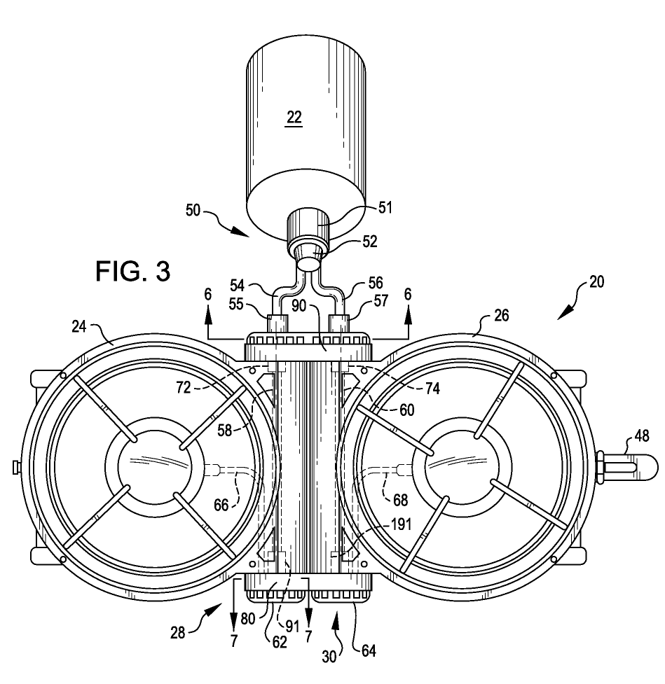

The prongs 40, 42 for each of the burner eyes 32, 34 are similar to conventional prongs for burner eyes, but in the embodiment shown, each prong 40 on the clamshell 24 is offset slightly relative to the counterpart prong 42 on the other clamshell 26. That is, each prong 40 is positioned so that when the folding stove 20 is folded into the compact configuration in FIG. 1, the prong does not engage the prong 42 on the opposite clamshell, but instead extends adjacent to the prong 42, and thus is slightly offset relative to the other prong. The slight offset may be, for example, one quarter of an inch or another sufficient amount to provide nesting of the two cooking grates 36, 38, when the clamshells 24, 26 are folded to the compact configuration shown in FIG. 1. The slight offset of the prongs 40, 42 can be seen from the top view in FIG. 3, and the nesting of the prongs 40, 42 can be seen in phantom in FIG. 5. This nesting effect provides more compact storage of the folding stove 20, yet, by not providing a significant offset, a symmetrical appearance is maintained for the cooking grates 36, 38, as can be seen in FIG. 3.

The folding stove 20 includes feet 44 on the rearward surfaces of the clamshells 24, 26. In addition, handles, such as handles 46, may be provided at an outer portion of the clamshells 24, 26. In the embodiment shown in the drawings, the handles 46 are positioned so that they are hinged from a top portion of the folding stove 20 when the folding stove is in the compact configuration of FIG. 1. A latch, such as a latch 48, may be provided for temporarily locking the folding stove 20 in the compact configuration.

In accordance with an embodiment, a regulator and manifold assembly 50 is provided for supplying gas from a canister, such as the gas canister 22, to the two fuel trains 28, 30. The regulator and manifold assembly 50 includes a regulator 51. Regulators are known in the burning appliances art and in general are designed to drop the fuel pressure from the high pressure of a fuel canister, such as the gas canister 22, to an operating pressure for a stove or another gas-operated appliance.

The regulator 51 is connected to a manifold 52. The manifold 52 splits the low pressure fuel stream exiting the regulator 51 into two conduits 54, 56. These two conduits 54, 56 each include a coupling 55, 57, for attaching onto appropriate structures (described below) at the ends of the fuel trains 28, 30. The regulator and manifold assembly 50 is shown attached in this manner in FIG. 3.

The two conduits 54, 56, when attached about the couplings 55, 57, are in fluid communication with internal fuel conduits 58, 60 that extend along the fuel trains 28, 30. The internal fuel conduits 58, 60 in an embodiment are straight pipes that extend co-axially with a rotational axis for each of the clamshells 24, 26. In an embodiment, the couplings 55, 57 are attached to the fuel trains 28, 30 in a manner such that the fuel trains 28, 30 may freely rotate relative to the couplings without gas loss. Such couplings are known in the art, and may be provided, for example by quick release couplings, such as are disclosed in U.S. Pat. No. 2,784,987, although many different couplings may be used.

Control knobs 62, 64 are mounted on the ends of the internal fuel conduits 58, 60 opposite the attachment of the couplings 55, 57. The control knobs 62, 64 are accessible from the outside of the folding stove 20. The control knobs 62, 64 include valves (described below) that open and close and regulate a flow of fuel provided from the internal fuel conduits 58, 60, and into gas flow lines 66, 68 which lead to the burner eyes 32, 34, respectively.

As can be seen in FIG. 6, the internal fuel conduits 58, 60 attach to probes 72, 74, which are configured for attachment to the couplings 55 of the regulator and manifold assembly 50. The probes 72, 74 are fitted within openings of the outer walls of the clamshells 24, 26, and are permitted to float freely therein. Allowing the probes to float freely permits longitudinal displacement of the fuel conduits 58, 60, allowing for manufacturing tolerances and/or expansion of the metal.

In accordance with an embodiment, a linkage, in the embodiment shown, a linkage 90, is provided for spacing the two fuel trains 28, 30, and permitting free rotation of these fuel trains 28, 30 relative to one another. In the embodiment shown, the linkage 90 receives the rear portion of the probes 72, 74, and is mounted for free rotation on surfaces 82, 84 of the probes 72, 74. The surfaces 82, 84 may be defined, for example, between the shoulders 76, 78 on the probes 72, 74 and a pair of lock nuts 86, 88. However, other structures may be provided that allow free rotation of the linkage 90 relative to the fuel trains 28, 30. For example, in the shown embodiment, the linkage 90 is rotatably mounted to the probes 72, 74, but the linkage may be attached at other locations to the fuel train. In addition to free rotation, the linkage 90 also maintains a constant spacing of the fuel trains 28, 30. To this end, the linkage 90 in one embodiment includes holes for receiving the probes 72, 74, so that the probes and the fuel trains 28, 30 may be rotated relative to the linkage but may not be moved outward or inward relative to one another.

Another linkage 80 (FIG. 7) may be provided at the opposite end for similarly spacing and allowing free rotation of the fuel trains 28, 30. If desired, the internal fuel conduits 58, 60 may be attached in a different manner at the opposite end, such as by anchoring the end to the internal fuel conduits 58, 60, because free flotation is not needed at both ends. The linkage 80 may be configured and arranged to recess a portion of the control knobs 62, 64.

For example, as shown in FIG. 7, the internal fuel conduit 58 may attach to a valve body 91, which in turn is anchored to the casing for the clamshell 24 by a jam nut 92. A valve stem 93 is positioned in the valve body 91 and is held in position by a stem nut 94. As is known, the control knob 62 rotates to move the valve stem 93 and open flow of fuel between the internal fuel conduit 58 and the gas flow line 66.

The linkage 80 is positioned between a shoulder 95 on the valve body 91 and the stem nut 94, and is free to rotate relative to the valve body in much the same manner that the other linkage 90 is free to rotate.

The linkages 80, 90 permit free rotation of the fuel trains 28, 30 along with the associated clamshells 24, 26. In this manner, when one of the clamshells, for example the clamshell 24, is rotated, the associated fuel train 28 and its internal fuel conduit 58 and gas flow line 66 all rotate with, and are fixed for movement with, the clamshell 24. Thus, there are no parts of the fuel train 28 that have to flex or move relative to the clamshell 24 during pivoting or rotation of the clamshell 24. Thus, no flexible lines or other structures to accommodate bending are required for the fuel train 28, reducing costs and simplifying routing of the fuel through the clamshell 24. Also, as is described above, the connection of the regulator and manifold assembly 50 via the coupling 55 to the fuel train 28 permits rotation without loss of fuel. Thus, the gas canister 22 and the regulator and manifold assembly 50 may remain stationary while rotation of the clamshell 24 is performed, with rotation between the regulator and manifold assembly 50 and the clamshell 24 being performed at the coupling 55. Similarly, the clamshell 26 and its associated fuel train 30 permit rotation of that side of the folding stove 20.

The folding stove 20 provides a variety of options for arrangement of the folding stove 20 during use. For example, one clamshell, such as the clamshell 26, may be folded upward while the other clamshell 24 extends substantially parallel to the ground. The fuel train 28, because it is fixed for rotation with the clamshell 24, allows pivoting of the clamshell 24, but still consistent combustion from the burner eye 32 in the clamshell 24.

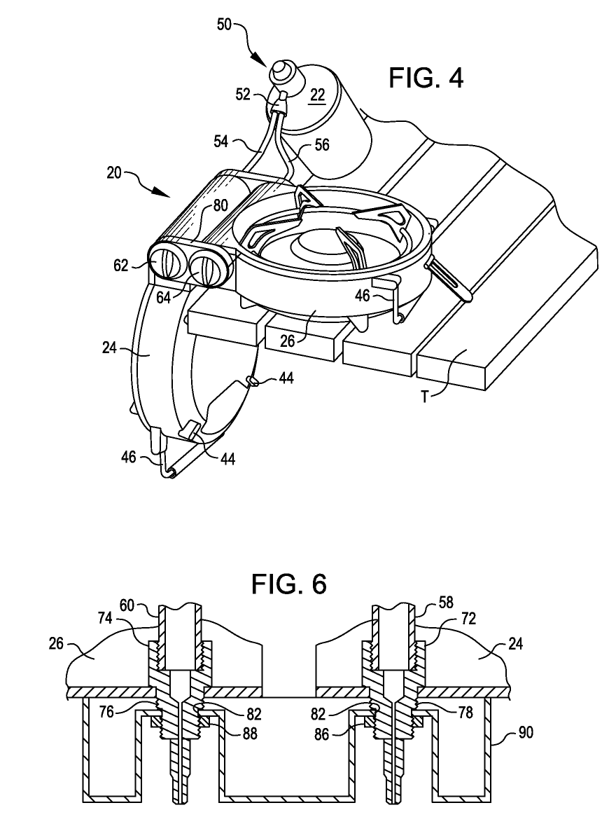

The folding stove 20 may be configured in other ways, such as in the configuration shown in FIG. 4, where the clamshell 24 is hanging downward relative to a table. This configuration provides stability for the folding stove 20, but uses a minimal amount of table space. In the embodiment shown, the folding stove 20 extends so that the clamshells 24, 26 form an angle greater than 180 degrees. However, if desired, a stop or stops may be provided to prevent rotation beyond 180 degrees.

Because the two clamshells 24, 26 may be pivoted but still provide consistent combustion, the folding stove 20 may be used on an uneven surface. This feature permits great flexibility for use and arrangement of the folding stove 20.

The regulator and manifold assembly 50 provides cost savings in that only a single regulator 51 is needed for two separate fuel trains, i.e., the fuel trains 28, 30. Moreover, gas is split outside of the folding stove 20, at the manifold 52. In this manner, a gas line does not have to extend between the two pivotable clamshells 24, 26.

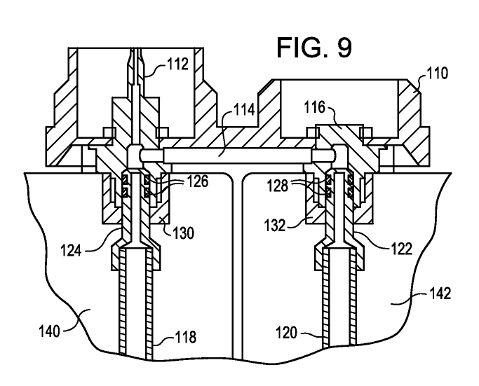

As an example of another alternate embodiment, a fuel train system for both of the clamshells 24, 26 may be connected to a single conduit leading from the cylinder 22. Such an embodiment is shown in FIG. 9. A linkage 110 shown in FIG. 9 includes a single probe 112 mounted at one side. This probe 112 includes an outer portion that is configured for connection to a connector that leads to a regulator, not shown but described in the previous embodiment. A fixed tube 114 extends between the probe 112 and a socket 116 on the opposite side of the linkage 110. The socket 116 and the probe 112 are fixed within the linkage 110. The tube 114 is also fixed within the linkage 110, and provides fluid communication between internal chambers of the probe 112 and the socket 116.

Like the previous embodiment, two fuel tubes 118, 120 extend along pivot points for the clamshells of this embodiment. Each of the fuel tubes 116, 120 includes an end piece 122, 124 that is arranged to fit within the socket 116 and the probe 112, respectively. The end pieces 122, 124 each include a pair of o-rings 126, 128 that provide a leak-proof connection of the end piece to the respective probe 112 or socket 116. Nuts 130, 132 fit over and outside a portion of the probe 112 and the socket 116 to secure them to the clamshells 140, 142, respectively.

During use, the o-rings 126, 128 permit the fuel tubes 118, 120 to rotate relative to the linkage 110 when either of the clamshells is rotated relative to the linkage. During this rotation, the o-rings 126, 128 maintain leak-proof fluid communication between the fuel tubes 118, 120 and the probe 112 and the socket 116. In this manner, fuel may be supplied to the probe 112, and that fuel may travel into the fuel tubes 118, 120 regardless of the orientation of the clamshells, and without leakage as a result of movement of the clamshells. Valves (not shown) may be provided on the opposite end of the fuel trains, which may be used to control burners for each of the clamshells.

The embodiment shown in FIG. 9 has an advantage over the previously described embodiment in that only a single connection is needed to the fuel canister 22. This feature permits greater flexibility in connecting a fuel source to the fuel trains.

Because the clamshells 24, 26 pivot along their fuel trains 28, 30, and the couplings 55, 57 attach at the pivot points, the connection of the couplings 55, 57 is the only portion of the fuel supply chain from the canister 22 to the burners 32, 34 that experiences rotation during pivoting of one or both of the clamshells 24, 26. Thus, the fuel trains 28, 30 are simplified in that they do not have to be designed to permit rotation with respect to the clamshells.

The dual pivoting function of the two clamshells 24, 26 permits compact storage of the folding stove 20. In addition, as described above, the offset of the cooking grates 36, 38 relative to one another permits compact storage of the folding stove 20.

The embodiment shown includes rounded clamshells 24, 26. In accordance with an embodiment, the outer portions of the clamshells 24, 26 extend outward beyond the control knobs 62, 64 and the rear linkage 90. In this manner, the outer surfaces of the clamshells 24, 26 may provide protection for the fuel trains 28, 30 and the control knobs 62, 64. In addition, because the folding stove 20 is more slender in the central portion that includes the fuel trains 28, 30 than at outer portions, there is less material for the fuel trains 28, 30, reducing the cost of production of the folding stove 20.

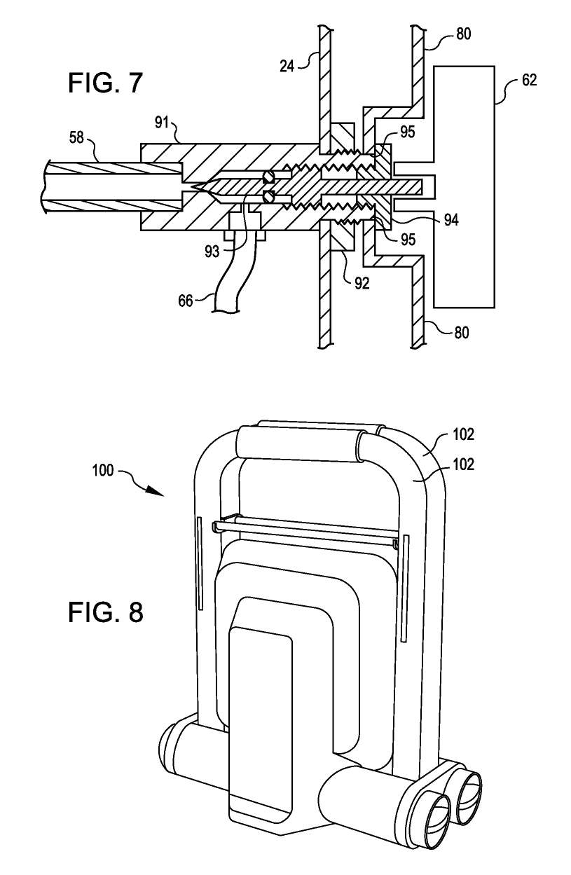

Alternate embodiments may be utilized. For example, in FIG. 8 a folding stove 100 is shown having a square instead of circular configuration. In this embodiment, tubes 102 extend around the stove 100 and form handles at the upper portion thereof.

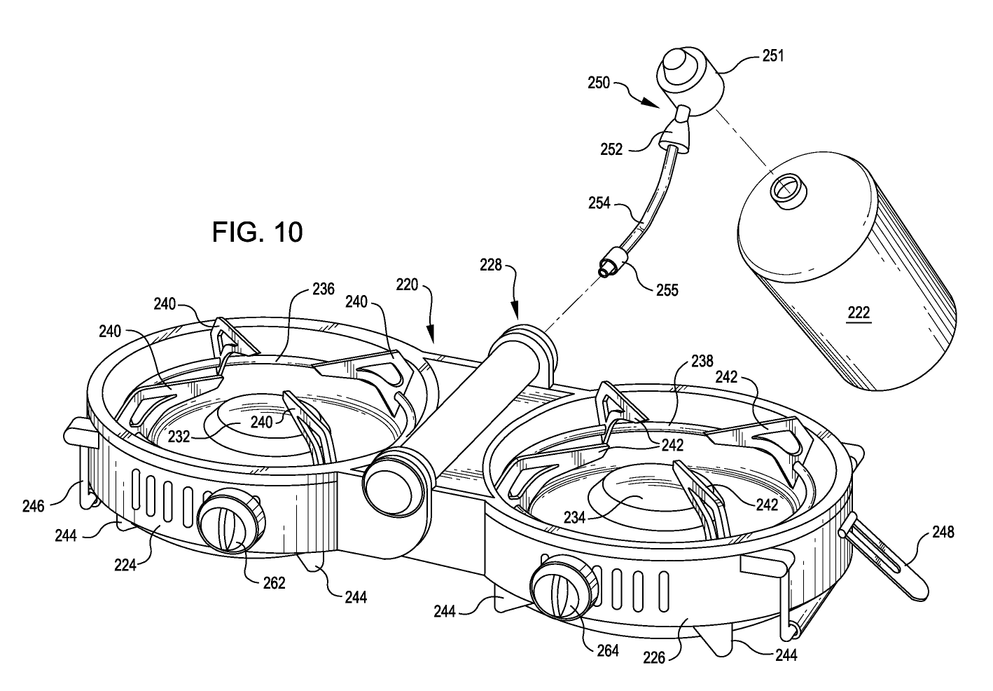

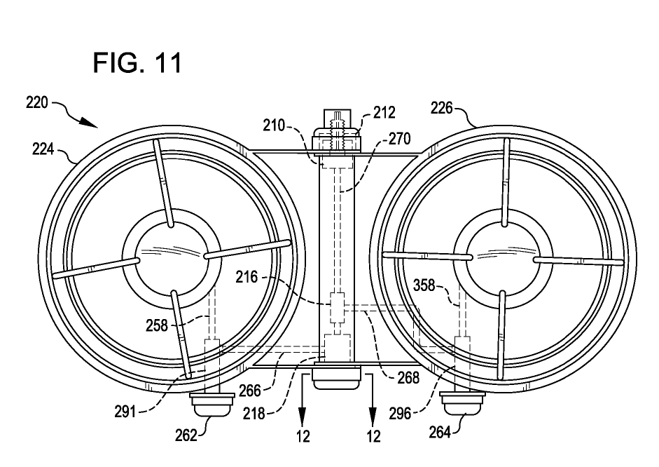

In accordance with an embodiment, FIG. 10 shows a folding stove 220 that includes two clamshells 224, 226. The two clamshells 224, 226 may be folded together in a storage configuration (not shown, but similar to the folded stove 20 in FIG. 1). As can be seen in FIG. 10, the two clamshells 224, 226 may be rotated outward about an axis, in the embodiment shown, a fuel train (shown generally at the area 228 in the drawings), so that the folding stove 220 is in an opened configuration. In the opened configuration, burner eyes 232, 234, one each in the two clamshells 224, 226, are exposed as cooking surfaces.

In accordance with an embodiment, an axis of rotation of the two clamshells 224, 226 shares a plane with the upper faces of the two clamshells 224, 226 when the folding stove 220 is in an open configuration. Locating the axis of rotation at this height allows the folding stove 220 to be put in a closed configuration with the faces of the clamshells 224, 226 flush against each other while having only one hinge. Of course, the same effect may be achieved by placing the axis of rotation in other locations. As a nonlimiting example, by having the face of the right clamshell 226 higher than the face of the left clamshell 224, the axis of rotation may be higher than the face of the left clamshell 224. As another example, the clamshells may be configured so that the right clamshell 226 is smaller than the left clamshell 224 and the right clamshell 226 is able to fit inside the right clamshell 224 when the folding stove 220 is in the closed configuration. In this latter example, the axis of rotation could be lower than the face of the clamshells 224, 226.

Although a single burner eye 232, 234 is shown on each clamshell 224, 226, more than one burner eye may be provided on one or both of the clamshells 224, 226. In the embodiment shown in the drawing, each of the burner eyes 232, 234 includes a cooking grate 236, 238 mounted around and partly over the respective burner eye 232, 234.

As described in the above embodiments, each prong 240 on the clamshell 224 may be offset relative to the counterpart prong 242 on the other clamshell 226. Other ways of keeping the prongs 240, 242 from engaging each other when attempting to put the folding stove 220 into a closed configuration may be used. For example, the prongs may be recessed into the clamshells 224, 226. Prongs may also be configured such that they are recessed into the clamshells 224, 226 when the folding stove 220 is in the closed position and raised when the folding stove 220 is in the open position. If a symmetrical appearance is not desired, the prongs may have a substantial offset. Other alternatives include making at least one of the cooking grates 236, 238 rotatable so that a user may rotate one of the cooking grates 236, 238 to a position such that the prongs 240, 242 do not engage each other when the stove 220 is put into a closed configuration. In addition, one or more of the cooking grates 236, 238 may be invertible so that a user may invert one or more of the cooking grates 236, 238 so that the prongs of the inverted grate(s) are below the face of its clamshell or otherwise in a configuration so as not to engage the prongs of the other clamshell when the stove 220 is put into a closed configuration. Of course, alternative configurations for keeping prongs from engaging each other are applicable to a stove with two axes, as described above, in general, with any folding stove.

The folding stove 220 includes feet 244 on the rearward surfaces of the clamshells 224, 226. In addition, handles, such as handles 246, may be provided at an outer portion of the clamshells 224, 226. In the embodiment shown in the drawings, the handles 246 are positioned so that they are hinged from a top portion of the folding stove 220 when the folding stove is in the compact configuration A latch, such as a latch 248, may be provided for temporarily locking the folding stove 220 in the compact configuration.

In accordance with an embodiment, a regulator and adaptor assembly 250 (FIG. 10) is provided for supplying gas from a canister, such as the gas canister 222, to the fuel train 228. The regulator and adaptor assembly 250 includes a regulator 251.

The regulator 251 is connected to an adaptor 252. The adaptor 252 channels the low pressure fuel stream exiting the regulator 251 into a conduit 254. The conduit 254 includes a coupling 255 for attaching onto the appropriate structure (described below) at the end of the fuel train 228. The regulator and adaptor assembly 250 may attach in a manner similar to that in which the coupling 55 attaches as shown in FIG. 3. As shown in FIG. 10, the regulator 251 and the adaptor 252 are two separate pieces. However, the regulator 251 may also be configured to accept the conduit 254 directly.

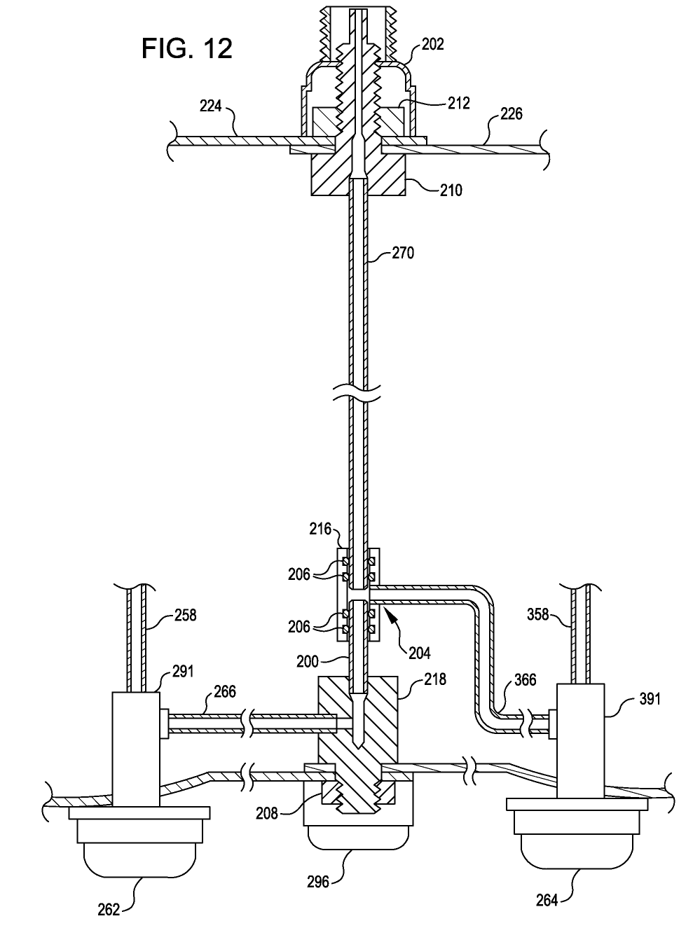

The conduit 254 when attached about the coupling 255 is in fluid communication with internal fuel conduit 270 (FIG. 12) that extends along the fuel train 228. The internal fuel conduit 270 in an embodiment is a straight pipe that extends co-axially with the rotational axis for the clamshells 224, 226. In an embodiment, the coupling 255 is attached to the fuel train 228 in a manner such that the fuel train 228 may freely rotate relative to the coupling 255 without gas loss. Such couplings are known in the art, and may be provided, for example, by quick release couplings, such as are disclosed in U.S. Pat. No. 2,784,987, although many different couplings may be used.

As can be seen in FIG. 12, the internal fuel conduit 270 attaches to a probe bushing 210 which is configured for attachment to the coupling 255 of the regulator and adaptor assembly 250. The probe bushing 210 is fitted within openings of the outer walls of the clamshells 224, 226. The probe bushing 210 may be permitted to float freely in the openings of the outer walls of the clamshells 224, 226. Allowing the probes to float freely permits longitudinal displacement of the fuel conduit 270, allowing for manufacturing tolerances and/or expansion of the metal or other materials, and permits rotation of the probe bushing relative to the openings of the clamshells 224, 226.

In an embodiment, the clamshells 224, 226 include openings that receive a portion of a probe bushing 210. In the embodiment shown, the probe bushing 210 is secured in the openings in a manner allowing for free rotation of the clamshells 224, 226 co-axially about the fuel train 228. For example, in accordance with an embodiment, as shown in FIG. 12, the probe bushing 210 may be wider on one end than openings extending through the clamshells 224, 226. The probe bushing is extended through the openings in the clamshells 224, 226, with the wider end against one side of the clamshells (in the embodiment shown in the drawings, the inside), and a nut 212 is placed on the bushing on the other side of the clamshells. The nut 212 does not tighten against the side of the clamshells 224, 226, but instead is spaced slightly from the clamshells, allowing for free rotation of the clamshells on the bushing. The nut 212 may be a lock nut to prevent accidental rotation off the bushing. In addition, a cap 202 may be provided for covering the nut 212.

When we talk about an axis of the fuel train 228, we mean an axis around which the two clamshells 224, 226 are able to rotate. In an embodiment, as seen in FIG. 11, a portion of the fuel train 228 is located on this axis and portions of the fuel train 228, such as the conduits 200, 266, 366, are able to rotate about it.

Other structures may be provided that allow free rotation of at least one of the clamshells 224, 226 with respect to the fuel train 228. For example, a cap similar to the cap 202 may include an opening for receiving the probe bushing 210 and may be situated between a nut (not shown) attached to the probe bushing 210 and the clamshells 224, 226.

In accordance with an embodiment, as shown in FIG. 12, openings in the clamshells 224, 226 in the side of the clamshells opposite the probe bushing 210 receive a portion of a blind bushing 218. In the embodiment shown, the blind bushing 218 is secured in the openings of the clamshells 224, 226 by a nut 208 in a manner allowing for free rotation of the clamshells 224, 226 co-axially about the fuel train 228. As shown in FIG. 12, the blind bushing may be wider than the openings of the clamshells 224, 226 on the end of the blind bushing 218 opposite the nut 208 further securing the blind bushing 218 in the openings. Other structures may be provided that allow for free rotation of the clamshells 224, 226 co-axially with the fuel train 228.

As shown in FIG. 12, in accordance with an embodiment, the conduit 270 extends between the probe bushing 210 and a sleeve 216. A second conduit 200 extends from the sleeve 216 to the blind bushing 218. As shown in FIG. 12, the conduit 270 may connect to the probe bushing 210 by fitting into a recession configured to receive the conduit 270 tightly. Other configurations may be used to connect the conduit 270 to the probe bushing 270. For example, both the conduit 270 and the probe bushing 210 may be threaded so that the conduit may be screwed into the probe bushing, there may be a weld between the conduit 270 and the probe bushing 210, or the probe bushing 210.

Also shown in FIG. 12, the interior of the sleeve 216 may have grooves for accepting o-rings 206 and an opening (fuel tap) 204 in one side for accepting a conduit 366. The o-rings ensure that the connection between the conduit 270 and the sleeve 216 is leak proof and permit the sleeve 216 to rotate relative to the conduits 200, 270. The conduit 200 provides a fluid connection between the sleeve 216 and the blind bushing 218. The ends of the conduits 200, 270 may have a chamfer to allow the conduits 200, 270 to be inserted into the sleeve 216 past the o-rings 206 without damaging or dislodging the o-rings 206. As shown in FIG. 12, the sleeve 216 is situated co-axially with the rotational axis of the two clamshells 224, 226.

In accordance with an embodiment, the fuel train 228 is configured so that there is a gap between the conduits 200, 270 allowing fuel to flow freely into the sleeve 216, thus allowing the fuel to pass from the conduit 270 to both the conduit 200 and to the conduit 366 via the fuel tap 204. The gap between the conduits 200, 270 also allows extra space for manufacturing tolerances and/or expansion of the metal or other materials. The end of the conduit 200 opposite the sleeve 216 may be connected to the blind bushing 218 in a manner similar to the connection of the conduit 270 to the probe bushing 210. In addition, the sleeve 216 may be configured with one or more internal lips or other stops for preventing the conduits 200, 270 from abutting each other and closing the gap.

Other connections, such as the connection of the conduit 200 to the blind bushing 218 or the connection of the conduit 270 to the probe bushing 210 may also be configured to allow rotation of the conduits to the bushings. For example, the probe bushing 210 may contain grooves and o-rings similar to the grooves and o-rings 206 of the sleeve 216 in order to receive the conduit 270 which may also have a chamfer at one or both ends. The blind bushing 218 may also be configured similarly.

As shown in FIG. 12, a conduit 266 provides a fluid connection between a valve body 291 for the clamshell 226 and the blind bushing 218, and a conduit 366 provides a fluid connection between the sleeve 216 and a valve body 391 for the clamshell 224. A mechanism, such as a valve, for opening and closing a passage between the conduits 266, 258 and between the conduits 366, 358 may function similarly to the valve shown in FIG. 7 and described above and may be included in each of the valve bodies 291, 391.

As can be seen in FIG. 11, the clamshells 224, 226 may be rotated with respect to each other about the axis of the fuel train 228. This may be achieved, for example, by fixing sets of parts of the fuel stove 220 together and providing a rotatable connection between the sets. For instance, as shown in FIG. 12, the valve body 291, conduit 266, blind bushing 218, conduit 200, and clamshell 224 are fixed for movement together. Likewise, the valve body 291, the conduit 366, the sleeve 216, and the clamshell 226 are fixed for movement together and the conduit 270 and the probe bushing 210 are fixed for movement together. The sleeve 216 provides a rotatable and leakproof connection between the conduits 266, 270, 366. Such a configuration allows the clamshells 224, 226 to rotate relative to each other without leakage in the fuel train. Accordingly, a user wishing to place the fuel stove 220 in the storage configuration from an open configuration may do so by rotating one clamshell relative to the other until the folding stove 220 is in a configuration similar to that show in FIG. 1. Likewise, a user wishing to put the stove in an open configuration can simply rotate one clamshell relative to the other until the stove is in a configuration such as that shown in FIG. 10 or similar to that shown in FIG. 4.

As shown in FIG. 12, the conduits 200, 270 are each able to rotate relative to the sleeve 216. As described above, this allows the clamshells 224, 226 to rotate co-axially with the axis of the fuel train 228. Other mechanisms for achieving this result may also be utilized. For example, the conduits 200, 270, 366 and the sleeve 216 may comprise a single rigid piece, chamfered at the ends, that is able to rotate relative to the probe bushing 210 and the blind bushing 218. This could be achieved, for example, by having o-rings in the probe bushing 210 and the blind bushing 218 configured to accept the ends of the single rigid piece. In addition, part or all of the fuel train may comprise flexible material, such as plastic or other tubing, which would allow the fuel train to flex with the rotation of the clamshells 224, 226 while maintaining a closed piping system between the canister 222 and the burners 232, 234.

In addition, even though the drawings show a connection (fuel supply connector) whereby fuel enters the fuel train 228 via a probe bushing 210 located at the rotational axis of the two clamshells 224, 226, different configurations may be used. For example, because the clamshells 224, 226 each contain a portion of the fuel train 228 and are able to rotate relative to one another without fuel leakage, fuel may enter the fuel train at a different location, such as through the walls of one of the clamshells 224, 226 or through the blind bushing 218.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A stove, comprising:
a first clamshell having a first cooking surface; and
a second clamshell having a second cooking surface and hinged to the first clamshell via a pivot connection, the pivot connection comprising a single pivot axis;
the first clamshell and the second clamshell being configurable between a first position in which the cooking surfaces are captured between the first and second clamshells and a second position in which the first and second cooking surfaces are exposed.

2. The stove of claim 1, wherein the first clamshell and the second clamshell are configurable between the two positions by rotating the first clamshell relative to the second clamshell at the pivot axis.

3. The stove of claim 1, further comprising a fuel train, at least a portion of which is positioned at the pivot axis.

4. The stove of claim 3, wherein the pivot axis is level with the top surface of the clamshells when the stove is in the second position.

5. The stove of claim 3, wherein the pivot axis is higher than the top surface of the clamshells when the stove is in the second position.

6. The stove of claim 1, further comprising a fuel supply connector located on or near the pivot axis.

7. The stove of claim 1, further comprising a fuel supply connector located in the first or second clamshell.

8. A stove, comprising:
a first clamshell having a first cooking surface;
a second clamshell having a second cooking surface and hinged to the first clamshell via a pivot connection, the first clamshell and the second clamshell being configurable between a first position in which the cooking surfaces are captured between the first and second clamshells and a second position in which the first and second cooking surfaces are exposed; and
a regulator and adaptor assembly, comprising:
a regulator for lowering fuel pressure of fuel from a source;
an adaptor in fluid communication with the regulator and arranged to direct fuel from the regulator to a fuel train able to supply fuel to the first and second clamshells; and
a coupling for connecting to the fuel train.

9. The stove of claim 8, wherein the regulator and adaptor assembly further comprises a conduit that extends from the adaptor to the fuel train.

10. The stove of claim 9, wherein the coupling is connected to the conduit, and wherein the pivot connection comprises a pivot axis and wherein the coupling is attached at the pivot axis.

11. The stove of claim 10, wherein the coupling is arranged and configured to permit leak-proof rotation of the fuel train relative to the conduit.

12. A stove, comprising:
a first clamshell having a first cooking surface and a first burner assembly;
a second clamshell having a second cooking surface and a second burner assembly connected to the first clamshell at a first rotatable connection and a second rotatable connection;
a fuel supply connector mounted on the first rotatable connection for attachment to a fuel source; and
a fuel train extending from the first rotatable connection in fluid connection with the first and second burner assemblies.

13. The stove of claim 12, wherein the fuel train comprises a sleeve rotatably connected to the fuel train and fluidly connecting the fuel train to the second burner assembly.

14. The stove of claim 13, wherein the sleeve is connected to the fuel train with at least one o-ring.

15. The stove of claim 12, wherein the first clamshell and the second clamshell are configurable between a first position in which the cooking surfaces are captured between the first and second clamshells and a second position in which the first and second cooking surfaces are exposed.

16. The stove of claim 15, wherein the fuel train is configured to be leak-proof.

17. The stove of claim 12, wherein the fuel train comprises:
a probe bushing;
a sleeve;
a first conduit connecting the probe bushing to the sleeve;
a blind bushing;
a second conduit connecting the blind bushing to the sleeve;
a first valve and a second valve;
a third conduit connecting the first valve to the blind bushing;
a fourth conduit connecting the second valve to the sleeve;
a fifth conduit connecting the first valve to the first burner assembly; and
a sixth conduit connecting the second valve to the second burner assembly.
